(19) United States
(12) Patent Application Publication
(10) Pub. No.: US 2007/0272757 A1
(43) Pub. Date: Nov. 29, 2007

(54) Multimedia book

(76) Inventors: Einat Pomranc, Tel Aviv (IL); Meir Gitelis, Moshav Bnei Atarot (IL)

Correspondence Address: EINAT POMRANC, 227 DIZINGOF ST. APT # 5, TEL AVIV, 63116, omitted

(21) Appl. No.: 11/441,440

(22) Filed: May 26, 2006

(51) Int. Cl. G06K 7/10; G06K 19/06

(52) U.S. Cl. 235/472.03; 235/468; 235/491

(57) ABSTRACT

The present invention is directed to a book in which a content is impressed on its pages by invisible ink, and lighting means (e.g. a lamp, a LED, etc.), for exposing the content. According to one embodiment of the invention the lighting means is mounted on a track, therefore enabling the lamp to move along the track. According to another embodiment of the invention, the lighting means is mounted on a pen used for impressing invisible ink, thereby enabling a user thereof to view the impressed content while being impressed. A page of the book may further comprise a light sensor; and an audial unit, for producing sound upon sensing light. A page may further comprise at least two polarizers and a picture underneath, thereby upon changing the angle between the polarizers, a visibility of the picture is changed correspondingly.

### FIELD OF THE INVENTION

The present invention relates to the field of games. More particularly, the invention relates to a multimedia book.

### BACKGROUND OF THE INVENTION

The term “multimedia” refers herein to a combined use of several media, each of which stimulating another sense.

The following applications are believed to represent the closest art:

1. U.S. Pat. No. 5,897,324

2. U.S. Pat. No. 4,002,355

### SUMMARY OF THE INVENTION

The present invention is directed to a book in which a content is impressed on its pages by invisible ink, and lighting means (e.g. a lamp, a LED, etc.), for exposing the content. According to one embodiment of the invention the lighting means is mounted on a track, therefore enabling the lamp to move along the track, thereby upon moving the lamp along the track while lighting the page, generating a motion effect of a content of the book. According to another embodiment of the invention, the lighting means is mounted on a pen used for impressing invisible ink, thereby enabling a user thereof to view the impressed content while being impressed. In a preferred embodiment of the invention, the lighting means is mounted inside the pen, resulting with a common pen form. A page of the book may further comprise a light sensor; and an audial unit, for producing sound upon sensing light. A page may further comprise at least two polarizers and a picture underneath, thereby upon changing the angle between the polarizers, a visibility of the picture is changed correspondingly.

### BRIEF DESCRIPTION OF THE DRAWINGS

The present invention may be better understood in conjunction with the following figures:

FIG. 1 schematically illustrates a multimedia book, according to a preferred embodiment of the invention.

FIG. 2 schematically illustrates a content exposing device for a multimedia book, according to one embodiment of the invention.

FIG. 3 schematically illustrates another content exposing device for a multimedia book, according to another preferred embodiment of the invention.

FIG. 4 schematically illustrates an invisible-ink pen, according to a further embodiment of the invention.

FIGS. 5A and 5B schematically illustrate an invisible-ink pen, according to a further embodiment of the invention.

FIG. 6 schematically illustrates a page of a multimedia book, according to a further embodiment of the invention.

FIG. 7 schematically illustrates a multimedia book, according to a further embodiment of the invention.

### DETAILED DESCRIPTION OF PREFERRED EMBODIMENTS

The present invention provides an educational game directed toward stimulating a child's curiosity and developing interest in optical phenomena by combining optical and physical phenomena with a book, a well-known tool even for infants. The game engages the interest of young children via sensory involvement.

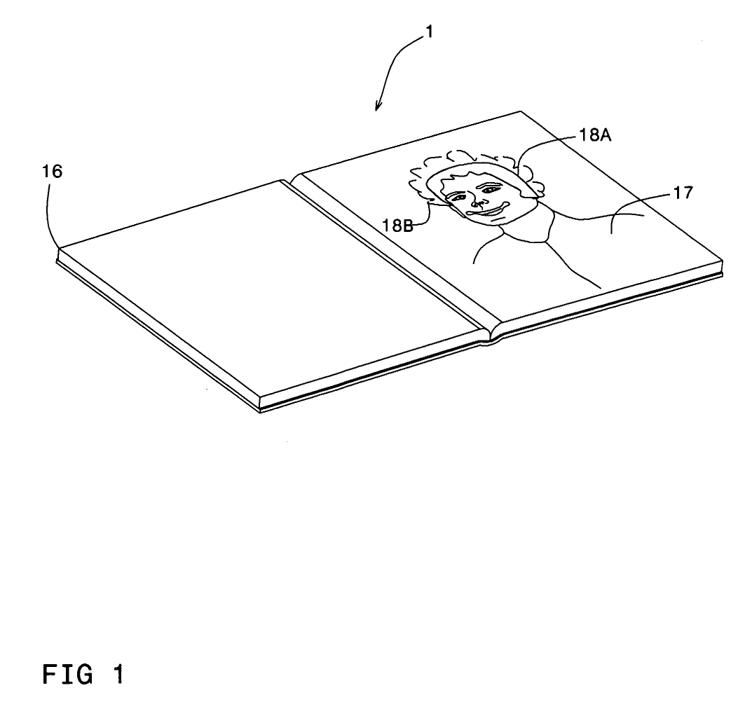

FIG. 1 schematically illustrates a multimedia book, according to a preferred embodiment of the invention. Book 1 comprises a plurality of pages 16. The content (text and/or illustration) 17 of the pages 16 may comprise a visible part 18A and/or an invisible part 18B (in dashed line). According to a preferred embodiment of the invention, the invisible part 18B is impressed by invisible ink. The invisible ink is of the kind that becomes visible upon lighting, such as UV (ultraviolet) ink.

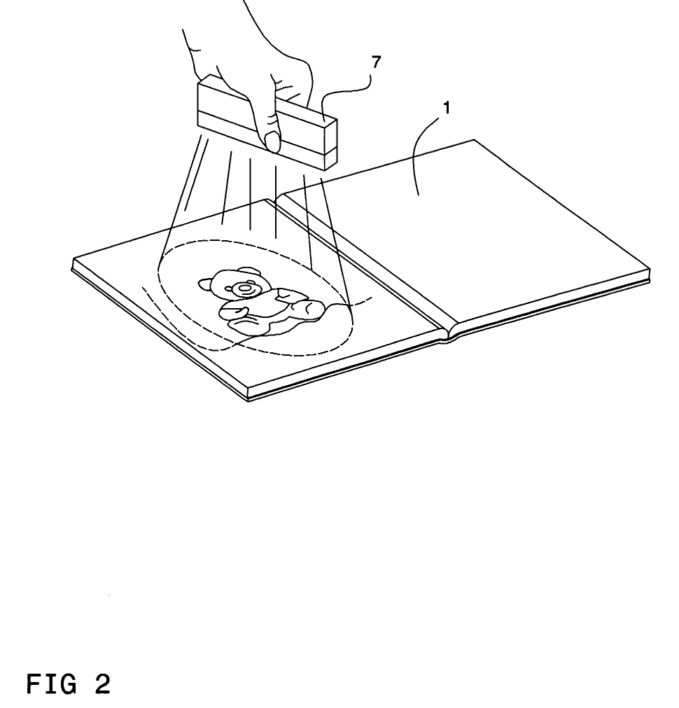

FIG. 2 schematically illustrates a content exposing device for a multimedia book, according to one embodiment of the invention. Upon illuminating page 16 by lamp 7, the invisible content 18B becomes visible. Furthermore, although the content 18B becomes visible upon lighting, it still may look differently than content 18A. This can be used for generating a unique visual effect to the content. For example, if the eyes of a clown in a picture are impressed by invisible ink, then upon lamp-lighting the figure, the eyes shine.

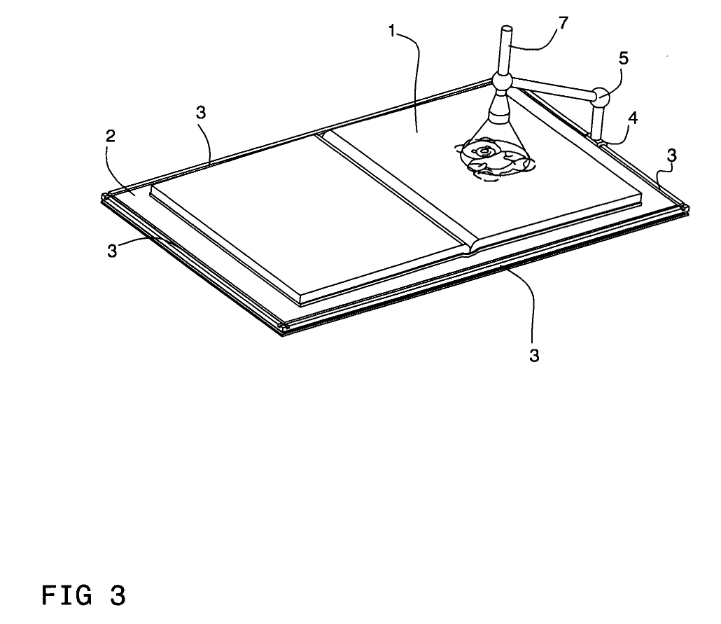

FIG. 3 schematically illustrates another content exposing device for a multimedia book, according to another preferred embodiment of the invention. The content revealing device 2 comprises:
a board 2;
one or more tracks 3, mounted on the board 2;
a carriage 4, that moves along the track(s) 3;
a light source 7 which illuminates the book 1;
a holder 5, mounted on carriage 4, on which the light source 7 is mounted.

By moving light source 7 along the track 3, a different area of the page is lighted, and consequently motion is generated, especially if multiple instances of a figure are impressed.

According to one embodiment of the invention, the user of a multimedia book is provided with a pen which uses invisible ink for impressing invisible content. Since the pen uses invisible ink, there is a difficulty to distinguish between an impressed region and other region. According to a preferred embodiment of the invention, this problem is solved by coupling the pen with LED, for lighting the writable area.

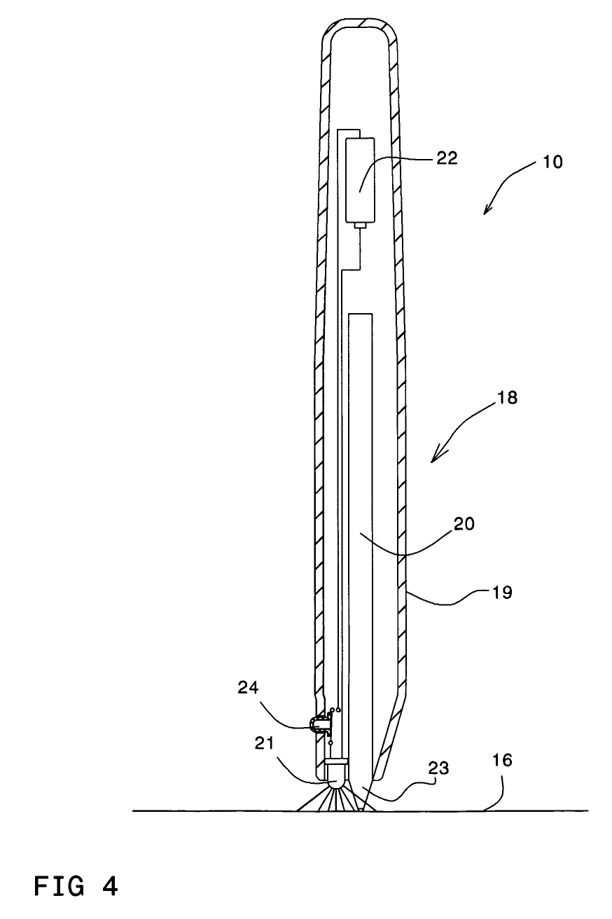

FIG. 4 schematically illustrates an invisible-ink pen, according to a further embodiment of the invention. The pen 10 comprises:
a container 20, for storing invisible ink;
a writing edge 23, through which the ink proceeds from container 20 to the page 16;
a LED 21, placed near writing edge 23, for lighting the close region to writing edge 23;
a power source (battery) 22; and
an on/off switch 24, for connecting and disconnecting the LED 21 from the power source 22.

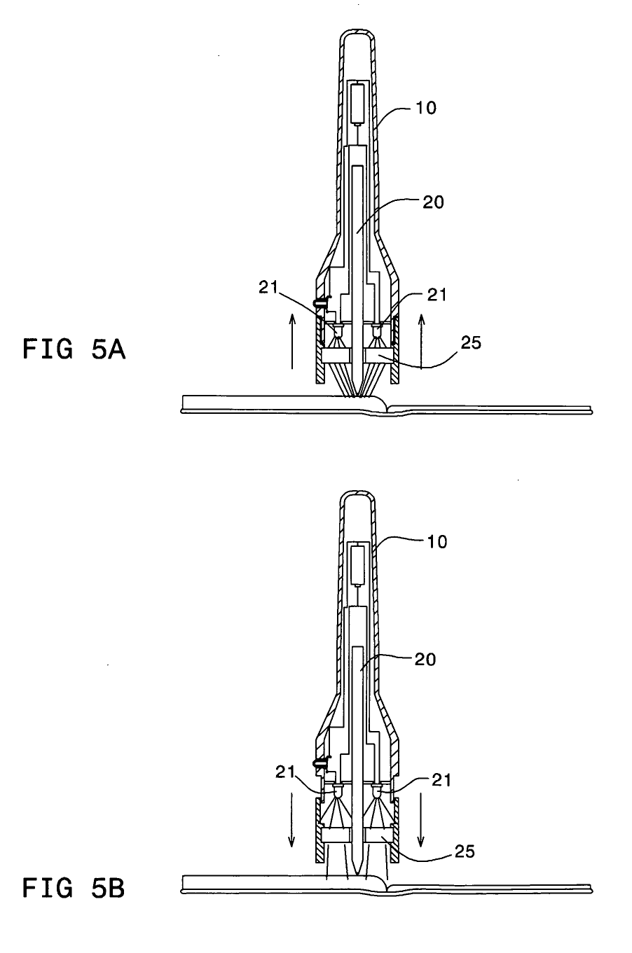

FIGS. 5A and 5B schematically illustrate an invisible-ink pen, according to a further embodiment of the invention. The invisible-ink pen 10 further comprises one or more lenses 25, which are used to focus/spread the light produced by LED 21. The LED 21 and/or the lens(es) 25 can move, thereby changing the illumination effect (intensity and focus).

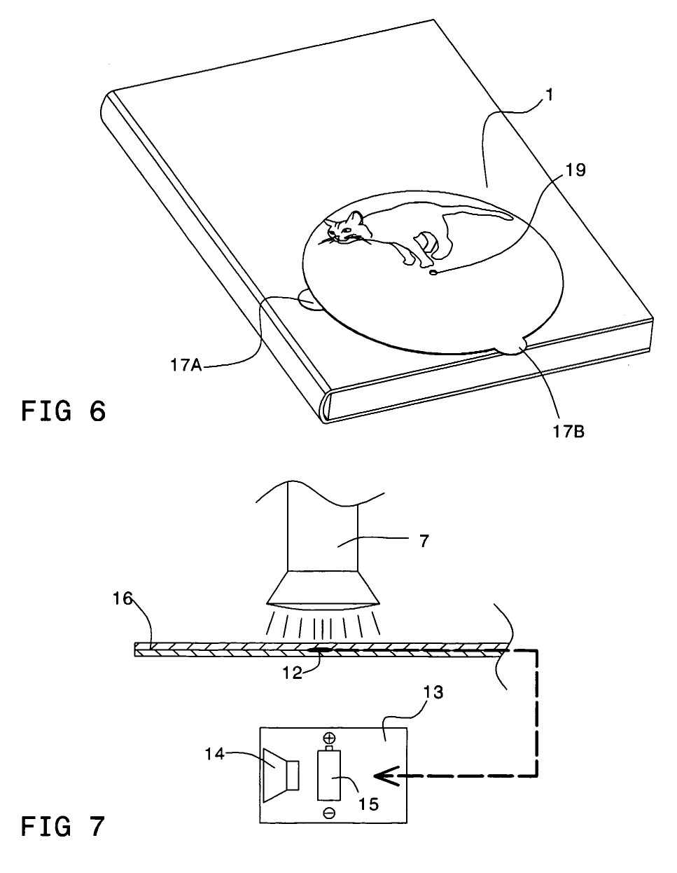

FIG. 6 schematically illustrates a page of a multimedia book, according to a further embodiment of the invention. In this embodiment one or more UV sensors 12 are embedded within a page 16. The sensors 12 are connected to audial unit 13, which is activated upon receiving a signal from a sensor 12. For example, assuming sensor 12 is placed on a lion's figure, when the light source 7 lights on sensor 12, the audial unit 13 plays “LION”. In the illustration of FIG. 6, the audial unit 13 comprises a power source 15, and a speaker 14, through which the sounds are relayed.

FIG. 7 schematically illustrates a multimedia book, according to a further embodiment of the invention. One of the pages of the book (in this case the cover page), comprises two polarizer units 17A and 17B; one may be fixed, and the other may rotate around a shaft. Upon rotating the polarizer, e.g. the upper polarizer 17B, an image impressed under the polarizers becomes visible or invisible, depending on the angle between the polarizers.

Those skilled in the art will appreciate that the invention can be embodied in other manners and means, all encompassing the scope of the invention. The embodiments described herein should be considered as illustrative and not restrictive.

1. A book comprising:
at least one page on which a content is impressed by invisible ink;
lighting means, for exposing said content.

2. A book according to claim 1, wherein said lighting means is selected from a group comprising: a LED, and a lamp.

3. A book according to claim 3, wherein said lighting means is mounted on a track, therefore enabling said lamp to move along said track, thereby upon moving said lamp along said track while lighting said page, generating a motion effect of a content of said book.

4. A book according to claim 1, wherein said lighting means is mounted on a pen used for impressing invisible ink, thereby enabling a user thereof to view the impressed content while being impressed.

5. A book according to claim 4, wherein said lighting means is mounted inside said pen, resulting with a common pen form.

6. A book according to claim 1, wherein said at least one page further comprises:
a light sensor; and
an audial unit, for producing sound upon sensing light.

7. A book according to claim 1, wherein said at least one page further comprises at least two polarizers and a picture underneath, thereby upon changing the angle between said polarizers, a visibility of said picture is changed correspondingly.

8. A book according to claim 1, wherein said invisible ink is based on ultraviolet.

9. A book, substantially as described and illustrated.
